(19) United States
(12) Patent Application Publication
(10) Pub. No.: US 2009/0292598 A1
(43) Pub. Date: Nov. 26, 2009

(54) CREDIT EARNING SYSTEM AND METHOD FOR OBTAINING MEDIA RIGHTS

(75) Inventors: Jacobus Dooms, Eindhoven (NL); Jeroen Franciscus Hubertus Van Agt, Eindhoven (NL); Bernardus Petrus Hendricus Catharina Van Gompel, Eersel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,475

(22) PCT Filed: Dec. 13, 2005
(86) PCT No.: PCT/IB05/54222

§ 371 Date: Jun. 12, 2007

Related U.S. Application Data
(60) Provisional application No. 60/635,678, filed on Dec. 13, 2004.

(51) Int. Cl. G06Q 50/00; G06Q 30/00; G06Q 10/00

(52) U.S. Cl. 705/14.11; 705/30

(57) ABSTRACT

A method and system for earning credits from a content rights provider/issuer (10) for obtaining content rights includes, in response to a trigger event (20), prompting (24) a user to provide a service in exchange for credits and receiving (26) a service performed by the user in favor of the content rights provider Credits from the content rights provider/issuer (10) are provided (28) to the user (18), and the credits may be redeemable (30) from the content rights provider/issuer (10) for a further product or service.

This disclosure relates to network communications and more particularly, to systems and methods for obtaining media rights by clients providing services to a content provider and/or content rights issuer.

Network communications offer the ability to market and sell goods and services directly to clients or the public at large. Online services include the purchasing of products, services or even the option to purchase such products or services. These online services may include providing electronic information, software or data to be downloaded or used by clients; most of this content is protected by copyrights. This environment may be referred to as a digital rights management environment (DRM).

In the DRM, copyrighted or otherwise sensitive material can be protected by a content provider. Full or limited access may be granted to subscribers, paying clients or other individuals who have been granted the rights to access, download, store or otherwise use the protected information. While the number of subscribers or individuals may be polled for feedback on given content, e.g., rate a book or record, such feedback is provided intermittently and not consistent across the entire segment of purchases or users.

It would be advantageous to provide motivation for clients or subscribers to provide services to a content provider in exchange for remuneration in a form that is network friendly.

A method for earning credits from a content provider for obtaining content rights includes, in response to a trigger event, prompting a user to provide a service in exchange for credits and receiving a service performed by the user in favor of the content provider. Credits from the content provider are provided to the user, and the credits may be redeemable from the content provider for a further product or service.

A method for earning credits toward obtaining content rights includes interacting with a content provider and performing a service by a user for the content provider. Credits are received from the content provider by the user, and the credits are redeemable from the content provider for further products or services.

A system for earning credits from a content provider for obtaining content rights includes a server having a plurality of content titles. The server provides an interface for communicating with at least one client. The server prompts a user, in response to a trigger event, to provide a service in exchange for credits. A credit storage module stores credits granted in accordance with a service performed by the user in favor of a content provider, the credits being redeemable from the content provider for a further product or service.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

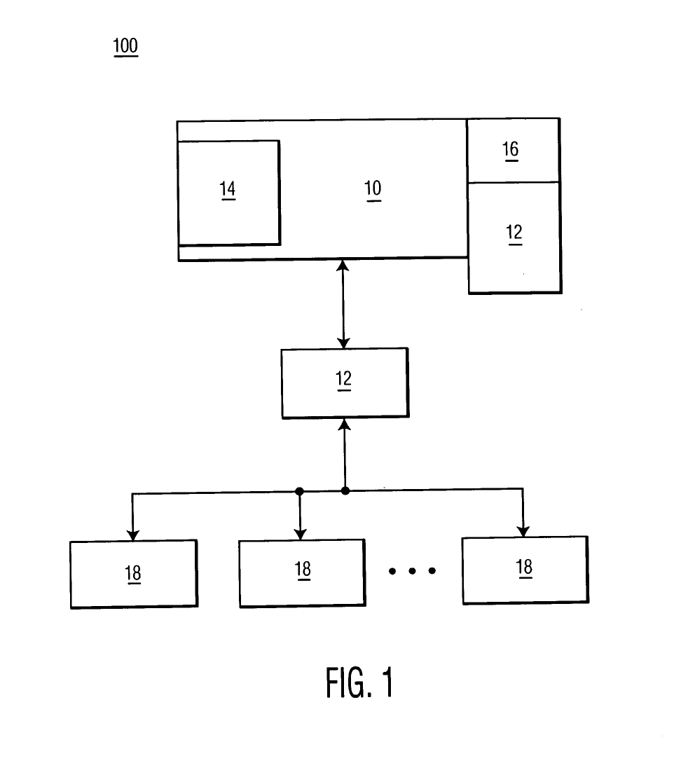

FIG. 1 is a block diagram showing a system/method for providing credits for service rendered by a user in favor of a content provider in accordance with one illustrative embodiment; and

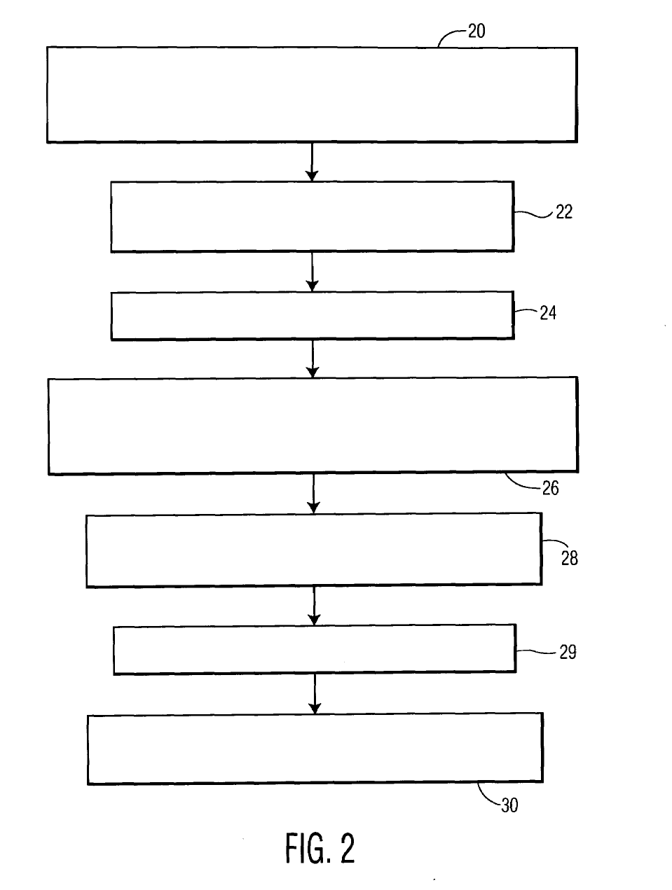

FIG. 2 is a block/flow diagram showing a system/method for providing credits for service rendered by a user in favor of a content provider in accordance with another illustrative embodiment.

The present disclosure describes an efficient way to motivate clients, users and/or subscribers to respond or otherwise provide services for a content provider in a digital rights management environment (DRM). By the present system and methods, the user earns credits or points with the content provider by providing useful services to the content provider. Such services may include reviewing or rating content, distributing content or generating referrals for services, adding meta-data, providing opinions, or any other useful service.

It should be understood that the elements shown in the FIGS. may be implemented in various forms of hardware, software or combinations thereof. Preferably, these elements are implemented in software on one or more appropriately programmed general-purpose digital computers having a processor and memory and input/output interfaces. The elements depicted in the FIGS. may be implemented in various combinations of hardware and software and provide functions which may be combined in a single element or multiple elements. In addition, the elements shown may be distributed over a network or networks or may be located at a single location.

Referring now to the drawings in which like numerals represent the same or similar elements and initially to FIG. 1, a block diagram shows a system/method for crediting client/user performed services in accordance with an illustrative embodiment. System 100 includes a content provider and/or content rights issuer 10, which is preferably managed by a server 16. Server 16 may include a personal computer or the like or any commercially available server appropriately programmed in accordance with this disclosure. Server 16 maintains and manages the product and service vending, information distribution or any other service that content provider and/or content rights issuer provides. In one example, content provider and/or content rights issuer 10 sells rights to downloadable content titles. Content titles may include a plurality of different media types. Content titles may include for example, music titles, video/movie titles, literary works, images, software titles, etc. Media storage 14 stores the content for say an entire content library, which is made available for purchase by users 18 over a network 12, such as, e.g., the Internet.

In other embodiments, content provider 10 may include a telephone company, a cable company or a satellite company, etc. Network 12 may include a telephone (digital subscriber (DSL) network, a cable network, a satellite or other wireless network.

User/client 18 may include hardware and/or software to implement ordering or otherwise obtaining the product or service from content provider 10. In an alternate embodiment, client 18 may include a personal computer, telephone, personal digital assistant, a set-top box or any other device for interacting with the content provider 10. It is to be understood that content provider/rights issuer 10 is preferably a digital rights management (DRM) provider; however, any product or service may be employed in accordance with embodiments of this disclosure. For example, content provider 10 may include a product distributor capable of taking orders from clients 18 over the Internet.

In one implementation, a user 18 accesses a content provider's website on server 16 over network 12 and orders content. Content is sent to client 18 taking the necessary security measures as are known in the art. In addition, server 16 may prompt a user to provide a service for the content provider 10. Server 16 may offer the client 18 credits in exchange for the performance of a service of the client, particularly in the context of the product or service ordered by the client, although other contexts are contemplated. Each client 18 who interacts with client provider 10 may be asked to open a credit account, which may be stored on server 16 or in a separate storage device 12. The credit account may be security protected so that the client may check account balances or transfer credits from one account to another, etc.

In a particularly useful embodiment, content provider 10 provides music or video titles for download by clients 18. In this example, a client 18 downloads a movie title, A, in exchange for payment of a license fee. At a later time or at the time of download, the client 18 is asked for a review or rating of movie A in exchange for one or more electronic credits. After the client views movie A, which may be verified in an on-demand/set-top box environment, for example, client is prompted for feedback. The client may decline or accept to provide feedback. However, since credits are offered in exchange for the feedback, the client will be motivated to respond to any inquiry or opinion questions posed by the content provider 10. The client 18 then provides input to the content provider 10 in exchange for credits. Information gathered by querying clients may be stored and processed as appropriate.

Credits may be awarded on a per question basis or on a weighted scale. For example, one question may have a weight of one credit while another question may have the weight of two or more credits. Credits may also be awarded based upon the amount of time elapsed from the time of inquiry to the time of response. This promotes rapid responses from the client(s).

Credits may be accumulated in an account, which may be associated with an individual, a household, a group of individuals or households or some other collective group. In this way, credits may be directed to a single account and/or transferable between accounts. Credits may be redeemed for DRM rights or other incentives. For example, five earned credits may entitle a user access to certain content such as a music title, an early purchase of an unreleased movie or other content, priority status for previewing a video game, etc. Credits may also be redeemed for other services, such as database access, higher membership status, extra features, etc.

In one embodiment, a client 18 receives credits for referring other clients to content provider 10. In yet another embodiment, the client earns credits by adding meta-data to media.

Referring to FIG. 2, an illustrative method is shown for earning and redeeming credits in accordance with one embodiment. In block 20, an interaction occurs between a content provider and a user. During this interaction a trigger event can occur which prompts the initiation of the process. The trigger event may include, for example, access the content provider, visiting a web site, activating/clicking on a button, enrolling in a credit program, making a purchase, downloading content, etc. In one embodiment, the client or user accesses the content provider. Access may be obtained over a communications network or the like. Once triggered, the user can optionally enroll in or otherwise set up a credit account in block 22. This may be performed automatically by the content provider or may be performed based upon one or more triggering events.

The user interacts/transacts with the content provider to obtain/download information or otherwise interact with content provider in accordance with the intended use. In block 24, the user is prompted or otherwise asked to perform a service or action, which would result in the user earning credits. In block 26, the user performs services and the content provider receives the benefit of the services. Performing of services by the user may take many forms. For example, the user may be asked to review and/or rate content, refer new users (referrals) to the content providers products or services, distribute media or content to others, add met-data or other information to the content provider's database, etc.

Upon performance of the activity/service of the user, the content provider provides remuneration, preferably in the form of credits to the user in block 28. The credits are preferably deposited in the user's account that may have been established earlier in the session or during an earlier session. Credits may be provided to the user in accordance with the type, quantity, quality, timeliness or other criteria for the response(s) given. Credits may be given for simply visiting the content provider's web site, by ordering a product or service, referring others, providing personal information or providing an opinion. In block 29, the credits may be stored for transferring some or all the credits to other accounts or by simply accumulating the credits on behalf of a user or entity.

In block 30, the user may redeem the earned credits. The earned credits may be redeemed for products or services of the content provider or products or services of other providers. DRM rights may be obtained for other content stored by the content provider and/or content rights issuer or by their partners.

Having described preferred embodiments for credit earning system and method for obtaining media rights (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims. Having thus described the details and particularity required by the patent laws, what is claimed and desired protected by Letters Patent is set forth in the appended claims.

1. A method for earning credits from a content rights provider for obtaining content rights, comprising the steps of:
in response to a trigger event (20), prompting (24) a user to provide a service in exchange for credits;
receiving (26) a service performed by the user in favor of the content rights provider; and
providing (28) credits from the content rights provider to the user, the credits being redeemable from the content rights provider for a further product or service.

2. The method as recited in claim 1, wherein the step of receiving a service includes receiving (26) an opinion on a content title from the user.

3. The method as recited in claim 2, wherein the content title includes at least one of a movie title, a music title, a software title, and a literary work.

4. The method as recited in claim 1, further comprising the step of redeeming (30) the credits for digital rights management (DRM) rights.

5. The method as recited in claim 1, wherein the step of redeeming the credits includes redeeming (30) the credits from other than the content rights provider.

6. The method as recited in claim 1, wherein the trigger event (20) includes an action of the user including at least one of visiting a web site, purchasing a good or service, selecting an option provided by the content rights provider.

7. The method as recited in claim 1, further comprising the step of establishing (28) a credit account for a user entity.

8. The method as recited in claim 1, wherein the step of receiving a service includes receiving (26) referrals from users or receiving a service for distribution of information to others.

9. The method as recited in claim 1, further comprising storing (29) credits electronically for users in a user account.

10. The method as recited in claim 9, wherein the user account (29) stores credits for a group of entities.

11. The method as recited in claim 1, further comprising the step of transferring (29) credits between user accounts.

12. A program storage device readable by machine, tangibly embodying a program of instructions executable by the machine to perform method steps as recited in claim 1.

13. A method for earning credits toward obtaining content rights, comprising the steps of:
interacting (20) with a content rights provider;
performing (26) a service by a user for the content rights provider; and
receiving (28) credits from the content rights provider by the user, the credits being redeemable from the content rights provider for further products or services.

14. The method as recited in claim 13, wherein the step of performing a service by a user for the content rights provider includes providing (26) an opinion on a content title.

15. The method as recited in claim 14, wherein the content title includes at least one of a movie title, a music title, a software title, and a literary work.

16. The method as recited in claim 13, further comprising the step of redeeming (30) the credits for digital rights management (DRM) rights.

17. The method as recited in claim 13, wherein the step of redeeming the credits includes redeeming (30) the credits from the content rights provider.

18. The method as recited in claim 13, wherein the step of interacting (20) with a content rights provider includes at least one of visiting a web site, purchasing a good or service, selecting an option provided by the content rights provider.

19. The method as recited in claim 13, wherein the step of interacting (20) with a content rights provider includes establishing a credit account with the content rights provider.

20. The method as recited in claim 13, wherein the step of performing (26) a service by a user for the content rights provider includes distributing information to others.

21. The method as recited in claim 13, wherein the step of performing (26) a service by a user for the content rights provider includes referring others to the content rights provider.

22. The method as recited in claim 13, wherein the step of receiving (28) credits from the content rights provider by the user includes storing credits electronically in a user account.

23. The method as recited in claim 10, wherein the user account stores (29) credits for a group of entities.

24. The method as recited in claim 1, wherein the step of receiving (28) credits from the content rights provider by the user includes transferring credits between user accounts.

25. A program storage device readable by machine, tangibly embodying a program of instructions executable by the machine to perform method steps as recited in claim 13.

26. A system for earning credits from a content rights provider for obtaining content rights, comprising:
a server (16) including a plurality of content titles, the server (16) communicating with at least one client (18), the server prompting a user, in response to a trigger event, to provide a service in exchange for credits; and
a credit storage module (12), which stores credits, granted in accordance with a service performed by the user in favor of a content rights provider, the credits being redeemable from the content rights provider for a further product or service.

27. The system as recited in claim 26, wherein the service includes one or more of giving an opinion on a content title from the user, receiving referrals from users or receiving a service for distribution of information to others.

28. The system as recited in claim 27, wherein the further product or service includes a content title.

29. The system as recited in claim 28, wherein the content title includes at least one of a movie title, a music title, a software title, and a literary work.

30. The system as recited in claim 26, wherein the credits are redeemed for digital rights management (DRM) rights.

31. The system as recited in claim 26, wherein the trigger event includes an action of the user including at least one of visiting a web site, purchasing a good or service, selecting an option provided by the content rights provider.

32. The system as recited in claim 26, wherein the credit storage module (12) stores a credit account for a user entity.

33. The system as recited in claim 32, wherein the credit account (12) stores credits for a group of entities.
